(19) United States
(12) Patent Application Publication
(10) Pub. No.: US 2006/0103790 A1
(43) Pub. Date: May 18, 2006

(54) Diffusion sheet with improved luminance and method of manufacturing the same

(76) Inventors: Jin-Sung Choi, Yongin-si (KR); Jheen-Hyeok Park, Seongnam-si (KR); Jeong-Hwan Lee, Suwon-si (KR); Hea-Chun Lee, Suwon-si (KR); Jin-Mi Jung, Seoul (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/254,990

(22) Filed: Oct. 19, 2005

(30) Foreign Application Priority Data
Oct. 20, 2004 (KR) 10-2004-84130

(51) Int. Cl. G02F 1/1335

(52) U.S. Cl. 349/112

(57) ABSTRACT

A diffusion sheet diffuses light to enhance luminance uniformity. The diffusion sheet includes a base film and a diffusion layer. The base film is optically transparent. The diffusion layer is formed on a surface of the base film. The diffusion layer includes a diffusion pattern having a plurality of first diffusion members that enhance front-view luminance. A cross-section of each of the first diffusion members having an arch shape, the cross-section being taken along a line that is substantially perpendicular to a longitudinal direction of the first diffusion members. The backlight assembly requires no prism sheet, which is usually used for enhancing front-view luminance, thus lowering the manufacturing cost.

### CROSS-REFERENCE TO RELATED APPLICATIONS

This application relies for priority upon Korean Patent Application No. 2004-84130 filed on Oct. 20, 2004, the content of which is herein incorporated by reference in its entirety.

### BACKGROUND OF THE INVENTION

1. Field of the Invention

The present invention relates generally to a diffusion sheet, a method of manufacturing the diffusion sheet, a method of manufacturing a roller for manufacturing the diffusion sheet, and a display apparatus having the diffusing sheet. More particularly, the present invention relates to a diffusion sheet capable of enhancing luminance, a method of manufacturing the diffusion sheet, a method of manufacturing a roller for manufacturing the diffusion sheet, and a display apparatus having the diffusing sheet.

2. Description of the Related Art

A liquid crystal display (LCD) apparatus displays an image by using liquid crystal molecules. LCD apparatuses have many merits such as light weight, low driving voltage, low power consumption, etc., and are used in various fields as display devices.

An LCD apparatus includes a backlight assembly and an LCD panel. The backlight assembly provides the LCD panel with light. The LCD panel displays an image by using the light provided from the backlight assembly.

A conventional backlight assembly includes a light source, a diffusion plate, a diffusion sheet, and a prism sheet. The light source generates light. The diffusion plate is disposed over the light source to diffuse light generated from the light source. The diffusion sheet and the prism sheet are disposed over the diffusion plate. The diffusion sheet further diffuses light, and the prism sheet enhances front-view luminance. The diffusion sheet includes a plurality of beads that diffuse light, and a binder that contains the beads. The binder containing the beads is coated on an upper surface of the diffusion sheet, and the beads are distributed on a lower surface of the diffusion sheet. While the diffusion sheet is useful for diffusing light, it has the negative effect of lowering the overall luminance of the display.

Another disadvantage of the diffusion sheet is that it raises the manufacturing cost because it takes a complex process to produce the diffusion sheet. The prism sheet is also relatively expensive. Therefore, the cost of an apparatus that employs both a prism sheet and a diffusion sheet ends up being undesirably high.

A method of cost-effectively producing a diffusion sheet that does not lower the luminance as much as the currently-available diffusion sheet is desired.

### SUMMARY OF THE INVENTION

The present invention provides a diffusion sheet capable of enhancing luminance.

The present invention also provides a method of manufacturing the above diffusion sheet.

The present invention also provides a method of manufacturing a roller for manufacturing the above diffusion sheet.

The present invention also provides a display apparatus having the above diffusion sheet.

In an exemplary diffusion sheet according to the present invention, the diffusion sheet diffuses light to enhance luminance uniformity. The diffusion sheet includes a base film and a diffusion layer. The base film is optically transparent. The diffusion layer is formed on a surface of the base film. The diffusion layer includes a diffusion pattern having a plurality of first diffusion members that enhance front-view luminance. A cross-section of each of the first diffusion members has an arch shape, the cross-section being taken along a line that is substantially perpendicular to a longitudinal direction of the first diffusion members.

The diffusion pattern may further comprise at least one second diffusion member. The cross-section of the second diffusion member has a triangular shape, wherein the cross-section is taken along a line that is substantially perpendicular to a longitudinal direction of the second diffusion member.

The second diffusion member may be disposed between the first diffusion members.

Sometimes, each of the first diffusion members may have a spherical shape or a triangular pyramid shape. The triangular pyramid shape may have a rounded top vortex. The first diffusion members may have the same size or different sizes.

According to a method of making a roller for manufacturing the diffusion sheet, a film is prepared. A print pattern is formed on the film to form a master film. Then, the master film is attached on a cylindrical face of a drum. The print pattern of the film may be hardened to form the master film.

According to a method of manufacturing a diffusion sheet, a base film that is optically transparent is prepared, and then a diffusion layer is formed on a surface of the base film. The diffusion layer includes a diffusion pattern having a plurality of first diffusion members that enhance front-view luminance. In order to form the diffusion layer, a roller having a master film rolled thereon is prepared. A resin is coated on the base film. The resin is patterned by the roller to form the diffusion pattern, and then the diffusion pattern is hardened.

In an exemplary liquid crystal display apparatus, the liquid crystal display apparatus includes a backlight assembly and a display panel. The backlight assembly includes a light source, a diffusion plate and a diffusion sheet. The light source generates light. The diffusion plate is disposed over the light source to diffuse the light. The diffusion sheet is disposed over the diffusion plate. The diffusion sheet has a base film that is optically transparent and a diffusion layer formed on the base film, the diffusion layer including a diffusion pattern having a plurality of first diffusion members that enhance front-view luminance. The display panel displays an image by using the light.

The backlight assembly of the invention eliminates the need to employ a prism sheet for front-view luminance enhancement. Thus, manufacturing cost is lowered.

Additionally, the diffusion sheet is manufactured through the roller having the master film attached to a surface of the roller to simplify a manufacturing process thereof. Furthermore, a manufacturing cost is lowered in comparison with a molding roller that has print patterns formed on a surface of the roller.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a perspective view illustrating a diffusion sheet according to an exemplary embodiment of the present invention;

FIG. 2 is a cross-sectional view illustrating the diffusion sheet in FIG. 1;

FIG. 3 is a cross-sectional view illustrating a diffusion sheet according to another exemplary embodiment of the present invention;

FIG. 4 is a perspective view illustrating a diffusion sheet according to still another exemplary embodiment of the present invention;

FIG. 5 is a cross-sectional view illustrating the diffusion sheet in FIG. 4;

FIG. 6 is a cross-sectional view illustrating a diffusion sheet according to still another exemplary embodiment of the present invention;

FIG. 7 is a perspective view illustrating a diffusion sheet according to still another exemplary embodiment of the present invention;

FIG. 8 is an enlarged view illustrating a portion ‘A’ in FIG. 7;

FIG. 9 is an enlarged view illustrating a portion of a diffusion sheet according to still another exemplary embodiment of the present invention;

FIG. 10 is a flow chart illustrating a method of manufacturing a roller for manufacturing a diffusion sheet;

FIG. 11 is a schematic cross-sectional view illustrating a process of manufacturing a master film in FIG. 10;

FIG. 12 is a perspective view illustrating a roller formed through the method in FIG. 10;

FIG. 13 is a flow chart illustrating a method of manufacturing a diffusion sheet according to an exemplary embodiment of the present invention;

FIG. 14 is a flow chart illustrating a process of forming the diffusion layer in FIG. 13;

FIG. 15 is a schematic cross-sectional view illustrating a process of manufacturing a diffusion sheet in FIG. 14;

FIG. 16 is an exploded perspective view illustrating a liquid crystal display apparatus according to an exemplary embodiment of the present invention;

FIG. 17 is a perspective view illustrating a flat fluorescent lamp in FIG. 16;

FIG. 18 is a cross-sectional view illustrating a light source in FIG. 17;

FIG. 19 is a perspective view illustrating another flat fluorescent lamp in FIG. 16; and

FIG. 20 is a cross-sectional view illustrating the flat fluorescent lamp in FIG. 19.

### DESCRIPTION OF THE EMBODIMENTS

It should be understood that the exemplary embodiments of the present invention described below may be modified in many different ways without departing from the inventive principles disclosed herein, and the scope of the present invention is therefore not limited to these particular flowing embodiments. Rather, these embodiments are provided so that this disclosure will be thorough and complete, and will fully convey the concept of the invention to those skilled in the art by way of example and not of limitation.

“Longitudinal direction,” as used herein, refers to the direction in which the longest dimension of a structure extends.

Hereinafter, the embodiments of the present invention will be described in detail with reference to the accompanying drawings.

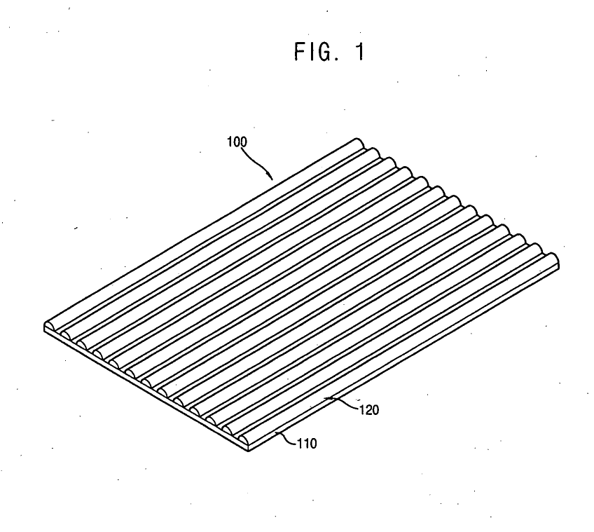

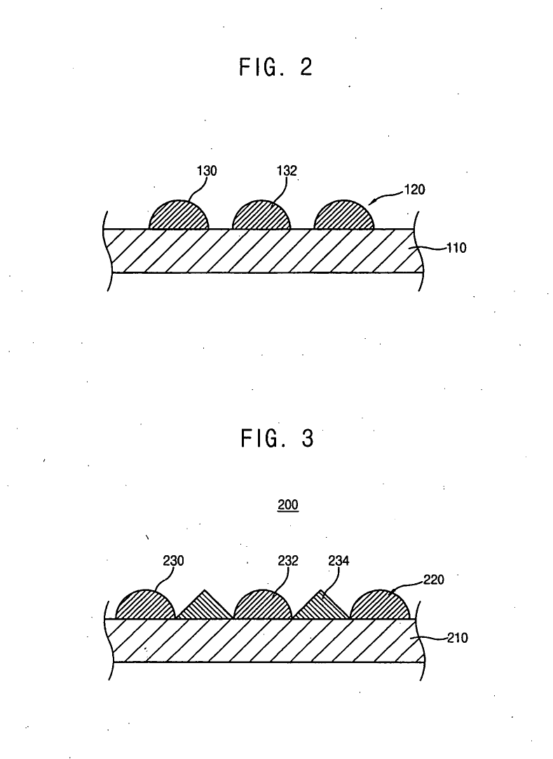

FIG. 1 is a perspective view illustrating a diffusion sheet according to an exemplary embodiment of the present invention, and FIG. 2 is a cross-sectional view illustrating the diffusion sheet in FIG. 1.

Referring to FIGS. 1 and 2, a diffusion sheet 100 according to the present embodiment includes a base film 110 and a diffusion layer 120.

The base film 110 may include an optically transparent material such as polycarbonate based resin, polysulfone based resin, polyacrylate based resin, polystyrene based resin, polyvinylchloride based resin, polyvinylalcohol based resin, polynorbonene based resin, polyester based resin, etc. These can be used alone or in combination. The base film 110 includes, for example, polyethyleneterephthalate (PET). Alternatively, the base film 110 may include polyethylenenaphthalate (PEN).

The diffusion layer 120 is formed on the base film 110. The diffusion layer 120 has a diffusion pattern 130. The diffusion layer 120 may include an optically transparent thermosetting resin that may be hardened by heat. Alternatively, the diffusion layer 120 may include an optically transparent photosetting resin that may be hardened by ultraviolet light.

The diffusion pattern 130 may include a plurality of diffusion members 132 extending parallel to each other. A cross-section of each of the diffusion members 132, which is taken along a line that is substantially perpendicular to a longitudinal direction of each of the diffusion members 132, has an arch-shape. In the embodiment shown, the diffusion members 132 are spaced apart from each other. However, in other embodiments, neighboring diffusion members 132 may make contact with each other.

FIG. 3 is a cross-sectional view illustrating a diffusion sheet according to another exemplary embodiment of the present invention.

Referring to FIG. 3, a diffusion sheet 200 according to the present embodiment includes a base film 210 and a diffusion layer 220. The base film 210 is substantially the same as the base film 110 in FIG. 1. Thus, any further explanation of the base film 210 will be omitted.

The diffusion layer 220 is formed on the base film 210. The diffusion layer 220 includes a diffusion pattern 230 for diffusing light. The diffusion layer 220 includes an optically transparent thermosetting resin that may be hardened by heat. Alternatively, the diffusion layer 220 may include an optically transparent photosetting resin that may be hardened by ultraviolet light.

The diffusion pattern 230 may include a plurality of first diffusion members 232 and at least one of second diffusion member 234. A cross-section of each of the first diffusion members 232, which is taken along a line that is substantially perpendicular to a longitudinal direction of each of the first diffusion members 232, has an arch-shape. A cross-section of the second diffusion members 234, which is taken along a line that is substantially perpendicular to a longitudinal direction of the second diffusion members 234, has a triangular-shape. The first and second diffusion members 232 and 234 extend substantially parallel to each other. Neighboring first and second diffusion members 232 and 234 may make contact with each other, as shown in FIG. 3. Alternatively, the neighboring first and second diffusion members 232 and 234 may be separated from each other. Where two first diffusion members 232 neighbor each other, they may make contact with each is other. Alternatively, two neighboring first diffusion members 232 may be separated from each other.

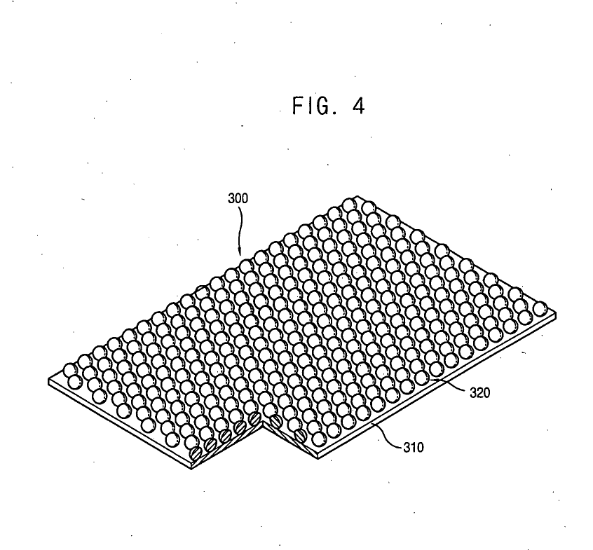

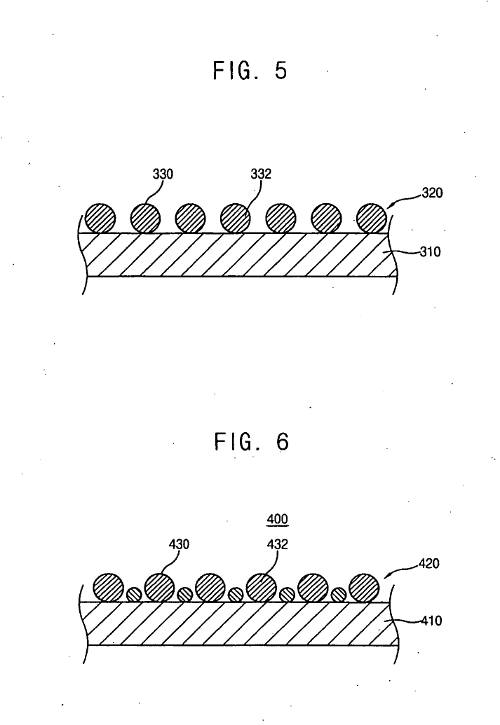

FIG. 4 is a perspective view illustrating a diffusion sheet according to still another exemplary embodiment of the present invention, and FIG. 5 is a cross-sectional view illustrating the diffusion sheet in FIG. 4.

Referring to FIGS. 4 and 5, a diffusion sheet 300 according to the present embodiment includes a base film 310 and a diffusion layer 320. The base film 310 is substantially the same as the base film 110 in FIG. 1. Thus, any further explanation of the base film 310 will be omitted.

The diffusion layer 320 is formed on the base film 310 and has a diffusion pattern 330. The diffusion layer 320 may include an optically transparent thermosetting resin that may be hardened by heat. Alternatively, the diffusion layer 320 may include an optically transparent photosetting resin that may be hardened by ultraviolet light.

The diffusion pattern 330 includes a plurality of diffusion members 332. Each of the diffusion members 332 has a spherical shape. The diffusion members 332 may be, for example, of a substantially the same size. In the embodiment shown, the diffusion members 332 are uniformly distributed on the base film 310. However, in other embodiments, the distribution of the diffusion members 332 may vary according to the region in the diffusion layer 320.

FIG. 6 is a cross-sectional view illustrating a diffusion sheet according to still another exemplary embodiment of the present invention.

Referring to FIG. 6, a diffusion sheet 400 according to the present embodiment includes a base film 410 and a diffusion layer 420. The base film 410 is substantially the same as the base film 110 in FIG. 1. Thus, any further explanation of the base film 410 will be omitted.

The diffusion layer 420 is formed on the base film 410 and has a diffusion pattern 430. The diffusion layer 420 may include an optically transparent thermosetting resin that may be hardened by heat. Alternatively, the diffusion layer 420 may include an optically transparent photosetting resin that may be hardened by ultraviolet light.

The diffusion pattern 430 includes a plurality of diffusion members 432. Each of the diffusion members 432 has a spherical shape. However, the sizes of the diffusion members 432 may vary. For example, the diffusion members 432 may come in at least two different sizes. In the embodiment shown, relatively small diffusion members 432 are disposed between relatively large diffusion members 432 and the diffusion members 432 are uniformly distributed on the base film 410. In other embodiments, the distribution of the diffusion members 432 may be varied according to the region on the diffusion layer 420.

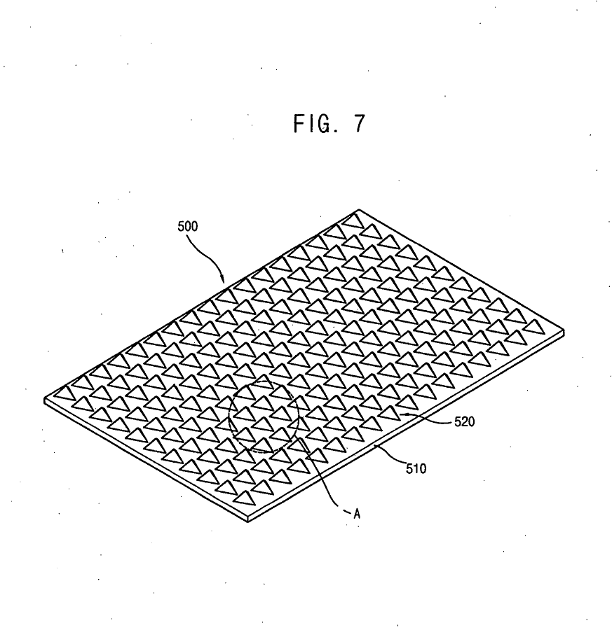

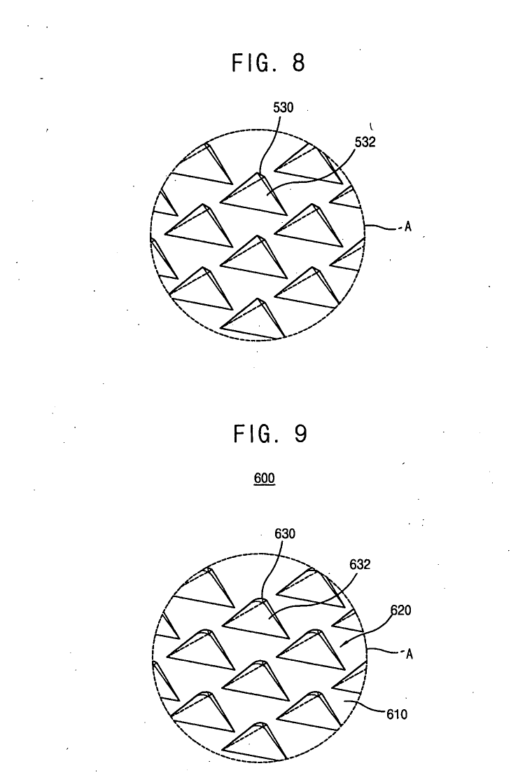

FIG. 7 is a perspective view illustrating a diffusion sheet according to still another exemplary embodiment of the present invention, and FIG. 8 is an enlarged view illustrating a portion ‘A’ in FIG. 7.

Referring to FIGS. 7 and 8, a diffusion sheet 500 according to the present embodiment includes a base film 510 and a diffusion layer 520. The base film 510 is substantially the same as the base film 110 in FIG. 1. Thus, any further explanation of the base film 510 will be omitted.

The diffusion layer 520 is formed on the base film 510 and has a diffusion pattern 530. The diffusion layer 520 may include an optically transparent thermosetting resin that may be hardened by heat. Alternatively, the diffusion layer 520 may include optically transparent photosetting resin that may be hardened by ultraviolet light.

The diffusion pattern 530 includes a plurality of diffusion members 532. Each of the diffusion members 532 has a triangular pyramid shape. The diffusion members 532 may have, for example, the same size. In the embodiment shown, the diffusion members 532 are uniformly distributed on the base film 510. In other embodiments, the distribution of diffusion members 532 may vary according to the region on the diffusion layer 520.

FIG. 9 is an enlarged view illustrating a portion of a diffusion sheet according to still another exemplary embodiment of the present invention.

Referring to FIG. 9, a diffusion sheet 600 according to the present embodiment includes a base film 610 and a diffusion layer 620. The base film 610 is substantially the same as the base film 110 in FIG. 1. Thus, any further explanation of the base film 610 will be omitted.

The diffusion layer 620 is formed on the base film 610. The diffusion layer 620 has a diffusion pattern 630. The diffusion layer 620 may include an optically transparent thermosetting resin that may be hardened by heat. Alternatively, the diffusion layer 620 may include an optically transparent photosetting resin that may be hardened by ultraviolet light.

The diffusion pattern 630 includes a plurality of diffusion members 632. Each of the diffusion members 632 has a triangular pyramid shape with a rounded top vortex. The rounded top vortex helps avoid damaging the diffusion pattern 630 or an optical member disposed on the diffusion pattern 630. The diffusion members 632 may have, for example, same size. In the embodiment shown, the diffusion members 632 are uniformly distributed on the base film 610. In other embodiments, the distribution of the diffusion members 632 may vary according to the region on the diffusion layer 620.

Hereinafter, a method of forming the above-explained diffusion sheets will be explained. First, a method of making a roller for manufacturing the diffusion sheets will be explained.

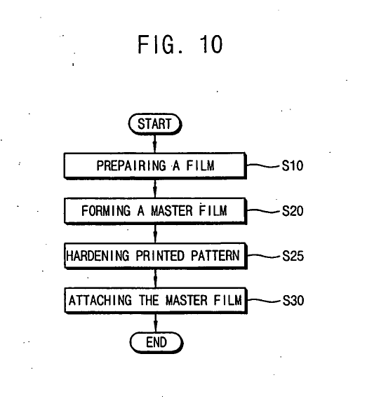

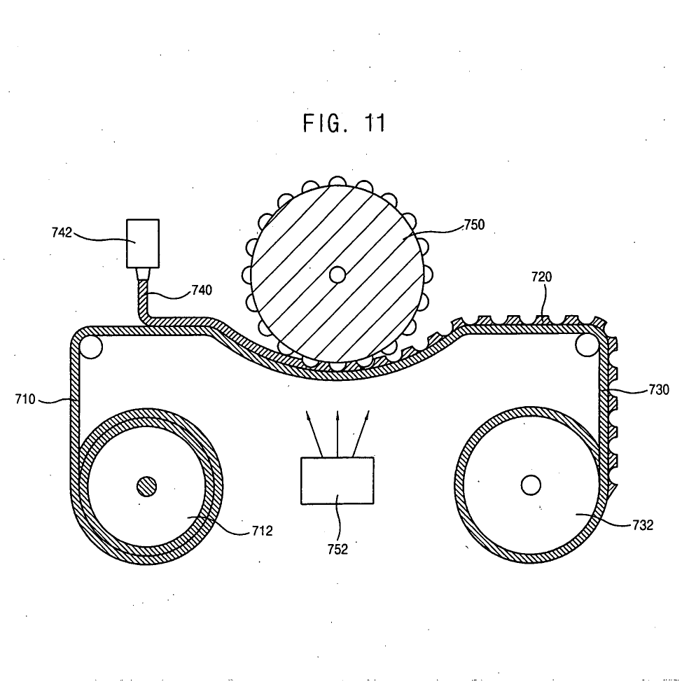

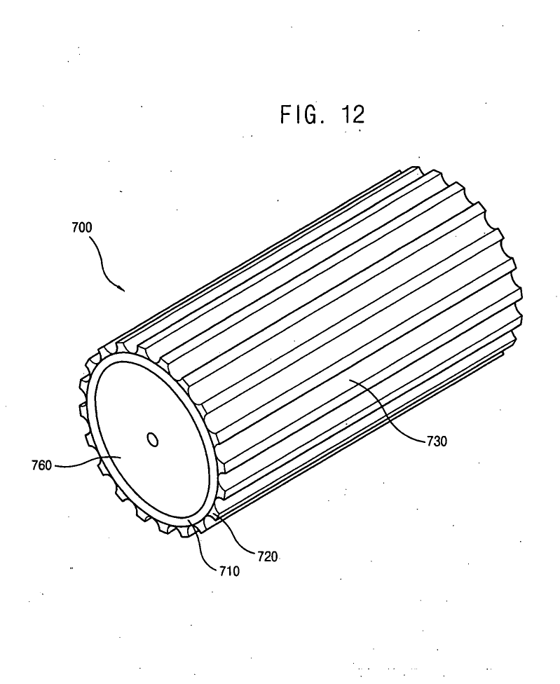

FIG. 10 is a flow chart illustrating a method of making a roller for manufacturing a diffusion sheet. FIG. 11 is a schematic cross-sectional view illustrating a process of manufacturing the master film of FIG. 10. FIG. 12 is a perspective view illustrating a roller formed through the method in FIG. 10.

Referring to FIGS. 10, 11 and 12, according to a method of making a roller for manufacturing a diffusion sheet, a film 710 is prepared (step S10). A print pattern is formed on the film 710 to form a master film 730 (step S20). The print pattern of the master film 730 is hardened (step S25). Then, the master film 730 is attached to a cylindrical surface of a drum 760 (step S30).

According to the step S10, the film 710 that is rolled by a first roller 712 is prepared. The film 710 includes, for example, polyethyleneterephthalate (PET).

According to the step S20, the print pattern 720 is formed on the film 710. In detail, a resin 740 is coated on the film 710 and compressed by a forming roller 750 having a pattern that is the reverse of the print pattern 720, so that the printed pattern 720 is formed on the film 710. The resin 740 corresponds to, for example, a photosetting resin that is hardened by ultraviolet light. Alternatively, the resin 746 may correspond to a thermosetting resin that is hardened by heat. The pattern of the forming roller 750 may be changed according to the desired print pattern 720.

According to the step S25, when the resin 740 is a photosetting resin, a UV generator 752 irradiates ultraviolet light onto the resin to harden the printed pattern of the resin 740. The UV generator 752 may be disposed under the forming roller 750. Alternatively, the UV generator 752 is disposed at a right side of the forming roller 750 in FIG. 11. Then, the master film 730 is rolled by a second roller 732.

According to the step S30, the master film 730 is cut and attached to a cylindrical surface of a drum 760 (see FIG. 12).

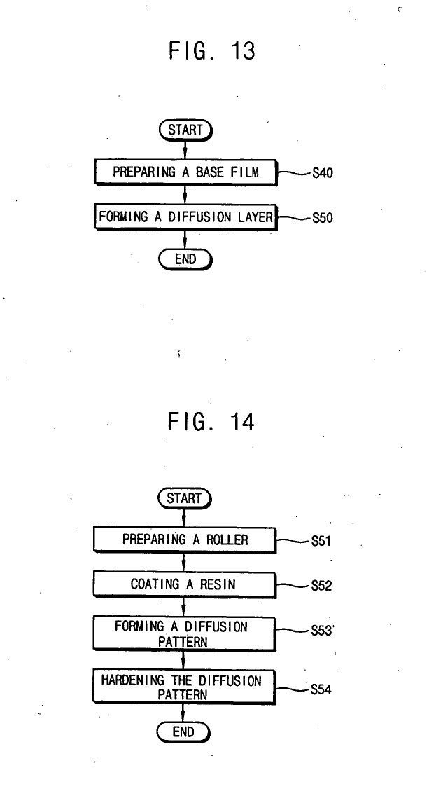

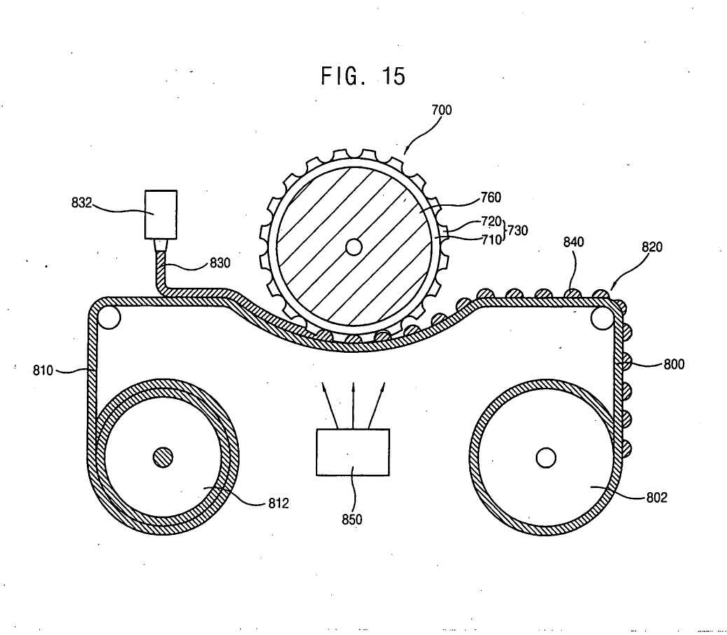

FIG. 13 is a flow chart illustrating a method of manufacturing a diffusion sheet according to an exemplary embodiment of the present invention. FIG. 14 is a flow chart illustrating a process of forming the diffusion layer in FIG. 13. FIG. 15 is a schematic cross-sectional view illustrating a process of manufacturing a diffusion sheet in FIG. 14.

Referring to FIGS. 13, 14 and 15, according to a method of manufacturing a diffusion sheet, a base film 810 is prepared (step S40), and then the diffusion layer 820 is formed on the base film 810 (step S50).

According to the step S40, a base film 810 rolled by the first roller 812 is prepared. The base film 810 includes an optically transparent material such as polycarbonate based resin, polysulfone based resin, polyacrylate based resin, polystyrene based resin, polyvinylchloride based resin, polyvinylalcohol based resin, polynorbonene based resin, polyester based resin, etc. The base film 810 includes, for example, polyethyleneterephthalate (PET). Alternatively, the base film 810 may include polyethylenenaphthalate (PEN).

According to the step S50, a diffusion layer 820 having a plurality of diffusion members having, for example, an arch-shaped cross-section is formed on the base film 810. The diffusion layer 820 is formed as follows.

A roller 700 is prepared (step S51) having the master film 730 rolled thereon. The master film 730 has the print pattern 720 that is the reverse of the diffusion pattern 840. The roller 700 may be manufactured through the same process as explained in FIG. 12. Thus, any further explanation on the manufacturing process for the roller 700 will be omitted.

Then, a resin 830 is coated on the base film 810 (step S52). A coater 832 coats the base film 810 with the resin 830, before the base film 810 is transferred to the roller 700. The resin 830 corresponds to, for example, a photosetting resin that may be hardened by ultraviolet light. Alternatively, the resin 830 may correspond to a thermosetting resin that may be hardened by heat.

Then, the diffusion pattern 840 is formed (step S53). A shape of the diffusion pattern 840 is determined by a shape of the print pattern 720 of the master film 730. By changing the master film 730, various diffusion patterns 840 may be formed. For example, the diffusion pattern 840 may have the arch cross-sectional shape, the triangular cross-sectional shape, a spherical shape, a triangular pyramid shape, etc.

Then, the diffusion pattern is hardened (step S54). When the resin 830 corresponds to the photosetting resin, a UV generator 850 irradiates ultraviolet light onto the resin to harden the printed pattern of the resin 830. The UV generator 850 may be disposed under the roller 700. Alternatively, the UV generator 850 is disposed at a right side of the roller 700 in FIG. 11. When the resin 830 corresponds to the thermosetting resin, the resin 830 is heated to be hardened. Then, the diffusion film 800 is rolled by a second roller 802.

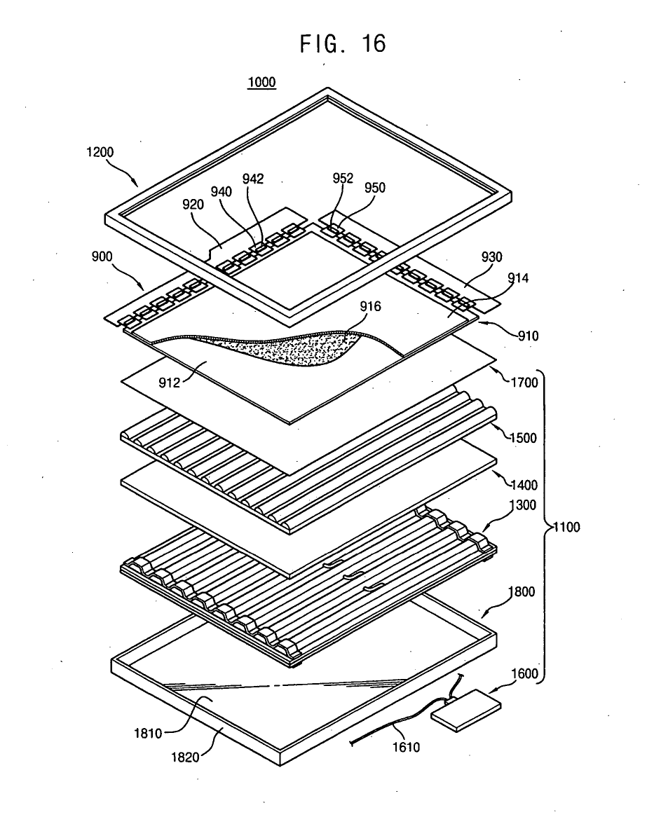

FIG. 16 is an exploded perspective view illustrating a liquid crystal display apparatus according to an exemplary embodiment of the present invention. The diffusion sheet according to the present embodiment may correspond to the diffusion sheets in FIGS. 1 through 9. Thus, any further explanation of the diffusion sheet will be omitted.

Referring to FIG. 16, a liquid crystal display (LCD) apparatus 1000 includes a backlight assembly 1100 and a display unit 900. The backlight assembly 1100 provides the display unit 900 with light. The display unit 900 displays an image by using the light provided by the backlight assembly 1100.

The backlight assembly 1100 includes a light source 1300, a diffusion plate 1400 disposed over the light source 1300, and a diffusion sheet 1500.

A flat fluorescent lamp (FFL) may be employed as the light source 1300. When an inverter 1600 applies a discharge voltage to the light source 1300, the light source 1300 generates light. Alternatively, a cold cathode fluorescent lamp (CCFL) may be employed as the light source 1300.

The diffusion plate 1400 enhances luminance uniformity of the light generated by the light source 1300. The diffusion plate 1400 is a relatively thick plate. The diffusion plate 1400 is spaced apart from the light source 1300. The diffusion plate 1400 includes, for example, polymethylmethacrylate (PMMA).

The backlight assembly 1100 may further include a reflective polarization film 1700 disposed on the diffusion sheet 1500. The reflective polarization film 1700 transmits a first light that satisfies a specific condition, and reflects a second light that does not satisfy the specific condition.

The backlight assembly 1100 may further include the inverter 1600 and a receiving container 1800. The receiving container 1800 receives the light source 1300. The inverter 1600 applies discharge voltage to the light source 1300.

The receiving container 1800 includes a bottom plate 1810 and sidewalls 1820 extending from the edge portion of the bottom plate 1810. The receiving container 1800 includes, for example, a metal. The inverter 1600 is disposed on a backside of the receiving container 1800. The inverter 1600 boosts a relatively low-level alternating voltage to be a relatively high-level alternating voltage that corresponds to the discharge voltage. The discharge voltage is applied to the light source 1300 through lamp wires 1610.

The display unit 900 includes an LCD panel 910, a data printed circuit board (PCB) 920 and a gate PCB 930. The LCD panel 910 displays an image. The data PCB 920 and the gate PCB 930 provide the LCD panel 910 with driving signals. The driving signals provided from the data PCB 920 and the gate PCB 930 are applied to the LCD panel 910 through a data flexible printed circuit (FPC) 940 and a gate FPC 950, respectively. For example, a tape carrier package (TCP), a chip on film (COF), etc. may be employed as the data FPC 940 and the gate FPC 950. The data and gate FPCs 940 and 950 include a data driver chip 942 and a gate driver chip 952, respectively, in order to control timing for applying the driving signals provided from the data and gate PCBs 920 and 930.

The data FPC 940 is bent, so that the data PCB 820 is disposed at a backside or a side of the receiving container 1800. When the LCD panel 910 and the gate FPC 950 include a specific signal pattern (not shown), the LCD panel 910 does not require the gate PCB 930.

The LCD panel 910 includes a thin film transistor (TFT) substrate 912, a color filter substrate 914 that faces the TFT substrate 912 and a liquid crystal layer 916 disposed between the TFT substrate 912 and the color filter substrate 914.

The TFT substrate 912 includes a glass substrate having a plurality of TFTs (not shown) formed thereon. The TFTs are arranged in a matrix shape. Each TFT includes a gate electrode that is electrically connected to one of the gate lines (not shown), a source electrode that is electrically connected to one of the source lines (not shown), and a drain electrode (not shown) that is electrically connected to a pixel electrode (not shown). The pixel electrode includes an electrically conductive and optically transparent material.

The color filter substrate 914 includes a glass substrate having red color filters, green color filters and blue color filters. The color filter substrate 914 further includes a common electrode (not shown) having an electrically conductive and optically transparent material.

When the TFT is turned on, electric fields are generated between the pixel electrode and the common electrode to rearrange the molecules of the liquid crystal layer 916. When the arrangement of the liquid crystal molecules is changed, the optical transmittance through the liquid crystal layer 916 is also changed to display a desired image. Therefore, when light provided from the backlight assembly 1100 passes through the liquid crystal layer 916, an image is displayed.

A top chassis 1200 surrounds the edge portions of the LCD panel 910, and the top chassis 1200 is combined with the receiving container 1800 to fasten the LCD panel 910 to the receiving container 1800. The top chassis 1200 also protects the LCD panel 910.

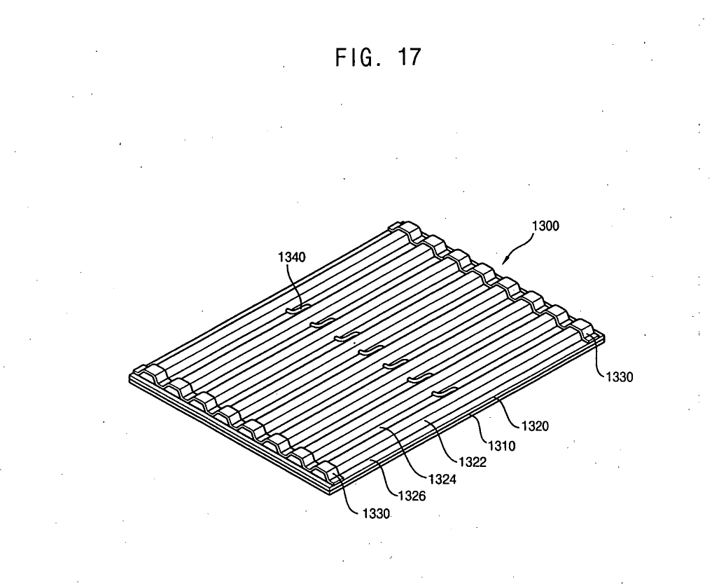

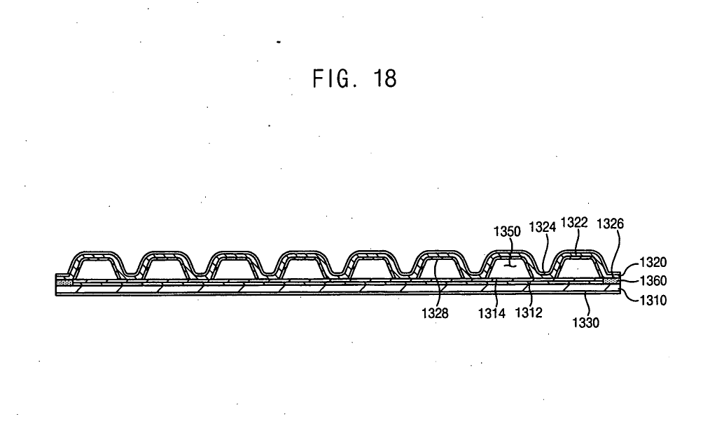

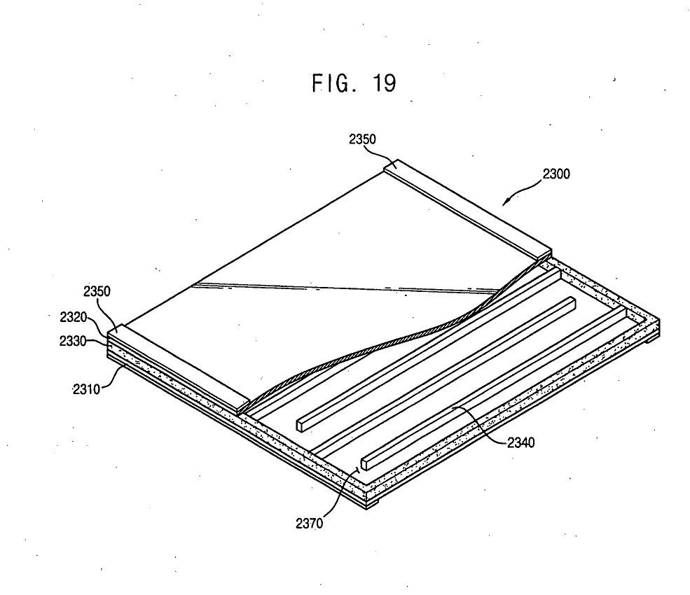

FIG. 17 is a perspective view illustrating a flat fluorescent lamp in FIG. 16, and FIG. 18 is a cross-sectional view illustrating a light source in FIG. 17.

Referring to FIGS. 17 and 18, the flat fluorescent lamp 1300 includes a first substrate 1310, a second substrate 1320 combined with the first substrate 1310 to form a plurality of discharge spaces 1350 and a pair of electrodes 250 that apply the discharge voltage to the discharge spaces 1350.

The first substrate 1310 has a rectangular plate shape. The first substrate 1310 includes, for example, glass. The first substrate 1310 optionally includes an ultraviolet light-blocking material in order to prevent leakage of ultraviolet light.

The second substrate 1320 has a plurality of discharge space portions 1322, a plurality of space dividing portions 1324, and a sealing portion 1326. The discharge space portions 1322 are spaced apart from the first substrate 1310 to define the discharge spaces 1350, when the first and second substrates 1310 and 1320 are combined with each other. Each of the space dividing portions 1324 is disposed between two discharge space portions 1322 adjacent to each other, and the space dividing portions 1324 make contact with the first substrate 1310 when the first and second substrates 1310 and 1320 are combined with each other. The sealing portion 1326 are located near the edge portions of the second substrate 1320. The first and second substrates 1310 and 1320 are combined with each other with the sealing portion 1326.

The second substrate 1320 is optically transparent so that visible light may pass through the second substrate 1320. The second substrate 1320 optionally includes an ultraviolet light blocking material in order to prevent leakage of ultraviolet light.

The second substrate 1320 may be formed through various methods. For example, a flat plate is heated and the heated flat plate may be compressed by a molding pattern. Alternatively, air may be blown to the heated flat plate to form the second substrate 1320 having the discharge space portions 1322, the space dividing portions 1324, and the sealing portion 1326.

Each of the discharge portions 1322 has an arch-shape. Alternatively, each of the discharge portions 1322 may have various shapes such as a semi-circular shape, a rectangular shape, a trapezoidal shape, etc.

The second substrate 1320 includes connection paths 1340. The connection paths 1340 connect two discharge spaces 1350 adjacent to each other. At least one connection path 1340 is disposed at each of the space dividing portion 1324. Air or discharge gas may move through the connection path 1340, when air in the discharge spaces 1350 is exhausted or discharge gas is injected into the discharge spaces 1350. The connection path 1340 may be formed through a process of forming the second substrate 1320. The connection path 1340 may have any of various known shapes including but not limited to an S-shape. When a length of the connection path 1340 increases, an interference between the discharge spaces 1350 is reduced to prevent the channeling effect that induces deterioration.

The first and second substrates 1310 and 1320 are combined with a sealing member 1360 such as frit. The frit includes glass and a metal. The frit has a lower melting point than glass. The frit is disposed between the first and second substrates 1310 and 1320 at the sealing portion 1326. The frit is melted by heating, thus combining the first and second substrates 1310 and 1320. The combining process is performed at a temperature of about 400° C. to about 600° C.

The space dividing portions 1324 of the second substrate 1320 make contact with the first substrate 1310 by a pressure difference between atmosphere and discharge spaces 1350. When the first and second substrates 1310 and 1320 are combined with each other, air in the discharge spaces 1350 is exhausted, and then discharge gas including mercury (Hg), neon (Ne), argon (Ar), etc. is injected into the discharge spaces 1350 until the pressure in the discharge spaces 1350 is in the range of about 50 Torr to about 70 Tbrr. As this pressure range in the discharge spaces 1350 is significantly lower than the atmospheric pressure (about 760 Torr), the space dividing portions 224 make contact with the first substrate 210 by the pressure difference between the discharge spaces 230 and the atmosphere.

The pair of electrodes 1330 is disposed at first and second ends of the flat fluorescent lamp 1300, respectively. The pair of electrodes 1330 overlaps with all of discharge spaces 1350. The pair of electrodes 1330 is disposed on an outer face of at least one of the first and second substrates 1310 and 1320. The electrodes 1330 may be formed inside the discharge spaces 1350.

The electrodes 1330 include an electrically conducting material. Silver paste including silver (Ag) and silicon oxide (SiO₂) may be coated on the outer face of at least one of the first and second substrates 1310 and 1320 to form the electrodes 1330. A metal powder may be coated through a spray coating method to form the electrode 1330. An insulating layer (not shown) may be formed on the electrodes 1330 in order to protect the electrodes 1330.

The flat fluorescent lamp 1300 further includes a light reflecting layer 1312, a first fluorescent layer 1314 and a second fluorescent layer 1328.

The light reflecting layer 1312 is disposed between the first substrate 1310 and the first fluorescent layer 1314. The light reflecting layer 1312 reflects visible light toward the second substrate 1320 to prevent the leakage of the visible light. The light reflecting layer 1312 includes a metal oxide such as aluminum oxide (Al₂O₃), barium sulfate (BaSO₄), etc.

The first fluorescent layer 1314 is formed on the light reflecting layer 1312, and the second fluorescent layer 1328 is formed on an inner face of the second substrate 1320. The first and second fluorescent layers 1314 and 1328 convert the ultraviolet light generated by the discharge gas into a visible light.

The first fluorescent layer 1314, the second fluorescent layer 1328 and the light reflecting layer 1312 are formed, for example, through a spraying method before the first and second substrates 1310 and 1320 are combined with each other. The first fluorescent layer 1314 and the light reflecting layer 1312 are formed on all portions of the inner face of the second substrate 1320 except for the sealing portion 1326. Alternatively, the first fluorescent layer 1314 and the light reflecting layer 1312 may not be formed at the space dividing portions 1324. The second fluorescent layer 1328 is formed on all portions of the inner face of the second substrate 1320. Alternatively, the second fluorescent layer 1328 may not be formed at the space dividing portions 1324 and the sealing portion 1326.

The flat fluorescent lamp 1300 optionally includes a protection layer (not shown) interposed between the first substrate 1310 and the light reflecting layer 1312. The protection layer may be interposed between the second substrate 1320 and second fluorescent layer 1328. The protection layer prevents chemical reaction between the mercury in the discharge gas and the glass of the first and second substrates 1310 and 1320, so that mercury loss and blackening of the first and second substrates 1310 and 1320 are prevented.

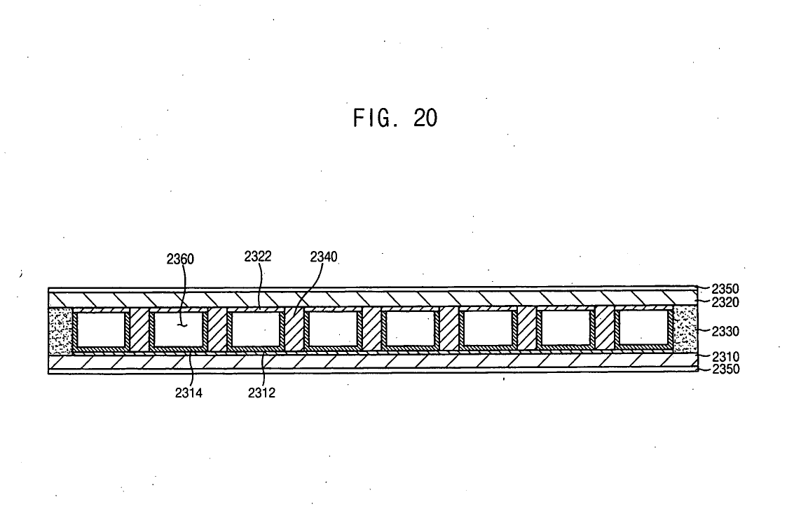

FIG. 19 is a perspective view illustrating another flat fluorescent lamp in FIG. 16, and FIG. 20 is a cross-sectional view illustrating the flat fluorescent lamp in FIG. 19.

Referring to FIGS. 19 and 20, a flat fluorescent lamp 2300 according to the present embodiment includes a first substrate 2310, a second substrate 2320, a sealing member 2330, a plurality of partition members 2340 and a pair of electrodes 2350.

The first and second substrates 2310 and 2320 have a rectangular plate shape. The first and second substrates 2310 and 2320 include an optically transparent material such as glass. The first and second substrates 2310 and 2320 are spaced apart from each other to define an internal space between the first and second substrates 2310 and 2320. The first and second substrates 2310 and 2320 optionally include a material for blocking ultraviolet light.

The sealing member 2330 is disposed between the first and second substrates 2310 and 2320 along edge portions of the first and second substrates 2310 and 2320 to combine the first and second substrates 2310 and 2320. The sealing member 2330 includes, for example, a same material as that of the first and second substrates 2310 and 2320. The sealing member 2330 is attached to the first and second substrates 2310 and 2320 through an adhesive member such as frit including glass and metal.

The partition members 2340 are disposed between the first and second substrates 2310 and 2320 to divide the internal space into a plurality of discharge spaces 2360. Each of the partition members 2340 has a substantially identical shape. Each of the partition members 2340 has, for example, a rod shape, and extends along a longitudinal direction of the first and second substrates 2310 and 2320. The partition members 2340 extend substantially parallel to each other and are spaced apart from one another by a substantially same distance. The partition members 2340 include, for example, a same material as that of the sealing member 2330. The partition members 2340 are attached to the first and second substrates 2310 and 2320 through the frit. Alternatively, the partition members 2340 may be formed through a dispenser.

The flat fluorescent lamp 2300 includes a plurality of connection paths 2370 connecting the neighboring discharge spaces 2360. For example, one of the end portions of the partition members 2340 is spaced apart from the sealing member 2330 to define the connection paths 2370. In detail, first ends of odd numbered partition members make contact with the sealing members 2330, and second ends of even numbered partition members make contact with the sealing members 2330. The connection paths 2370 are disposed between two opposing edges of the flat fluorescent lamp 2300 as they go from one partition member 2340 to another. Therefore, the discharge spaces 2360 are connected to each in a serpentine shape.

Alternatively, each of the partition members 2340 may include a hole connecting the discharge spaces 2360 that are adjacent to each other.

The electrodes 2350 are disposed such that a longitudinal direction of the electrodes 2350 is substantially perpendicular to a longitudinal direction of the partition members 2340. The electrodes 2350 are disposed on at least one of the outer faces of the first and second substrates 2310 and 2320. Alternatively, the electrodes 2350 may be disposed inside the discharge spaces 2360.

The flat fluorescent lamp 2300 further includes a light reflecting layer 2312, a first fluorescent layer 2314 and a second fluorescent layer 2322. The light reflecting layer 2312 is formed on an inner face of the first substrate 2310. The first fluorescent layer 2314 is formed on the light reflecting layer 2312. The second fluorescent layer 2322 is formed on an inner face of the second substrate 2320. The first fluorescent layer 2314 may be formed on a side face of the partition members 2340. The light reflecting layer 2312, the first fluorescent layer 2314 and the second fluorescent layer 2322 may not be formed on regions of the first and second substrates 2310 and 2320 that include the partition members 2340.

According to the present invention, the diffusion sheet includes the diffusion layer having various shapes to enhance luminance. Therefore, the backlight assembly requires no prism sheet that enhances front-view luminance, so that manufacturing cost is lowered.

Additionally, the diffusion sheet is manufactured through a roller having the master film attached to a surface of the roller to simplify a manufacturing process thereof. Furthermore, a manufacturing cost is lowered in comparison with a molding roller that has print patterns formed on a surface of the roller.

Having described the exemplary embodiments of the present invention and its advantages, it is noted that various changes, substitutions and alterations can be made herein without departing from the spirit and scope of the invention as defined by appended claims.

What is claimed is:

1. A diffusion sheet that diffuses light to enhance luminance uniformity, the diffusion sheet comprising:
a base film that is optically transparent; and
a diffusion layer formed on a surface of the base film, the diffusion layer including a diffusion pattern having a plurality of first diffusion members that enhance front-view luminance, wherein a cross-section of each of the first diffusion members has an arch shape, the cross-section being taken along a line that is substantially perpendicular to a longitudinal direction of the first diffusion members.

2. The diffusion sheet of claim 1, wherein the first diffusion members extend substantially parallel to each other.

3. The diffusion sheet of claim 1, wherein the diffusion pattern further comprises at least one second diffusion member, a cross-section of the second diffusion member having a triangular shape, the cross-section being taken along a line that is substantially perpendicular to a longitudinal direction of the second diffusion member.

4. The diffusion sheet of claim 3, wherein the second diffusion member is disposed between the first diffusion members.

5. The diffusion sheet of claim 4, wherein the first and second diffusion members extend substantially parallel to each other.

6. The diffusion sheet of claim 1, wherein each of the first diffusion members has a triangular pyramid shape.

7. The diffusion sheet of claim 6, wherein the triangular pyramid shape has a rounded top vortex.

8. The diffusion sheet of claim 1, wherein the base film comprises polyethyleneterephthalate (PET).

9. The diffusion sheet of claim 1, wherein the diffusion layer comprises a photosetting resin.

10. A diffusion sheet that diffuses light to enhance luminance uniformity, the diffusion sheet comprising:
a base film that is optically transparent; and
a diffusion layer formed on a surface of the base film, the diffusion layer including a diffusion pattern having a plurality of first diffusion members that enhance front-view luminance, wherein each of the first diffusion members has a spherical shape.

11. The diffusion sheet of claim 10, wherein the first diffusion members have different sizes from one another.

12. A method of manufacturing a roller for manufacturing the diffusion sheet, comprising:
preparing a film;
forming a print pattern on the film to form a master film; and
attaching the master film on a cylindrical face of a drum.

13. The method of claim 12, further comprising hardening the print pattern of the film to form the master film.

14. The method of claim 12, wherein the print pattern is formed using a photosetting resin that is hardened when ultraviolet light is irradiated thereto.

15. A method of manufacturing a diffusion sheet, comprising:
preparing a base film that is optically transparent; and
forming a diffusion layer on a surface of the base film, the diffusion layer including a diffusion pattern having a plurality of first diffusion members that enhance front-view luminance.

16. The method of claim 15, wherein the diffusion layer is formed by:
preparing a roller having a master film rolled thereon;
coating a resin on the base film;
patterning the resin by the roller to form the diffusion pattern; and
hardening the diffusion pattern.

17. The method of claim 16, wherein the master film comprises a print pattern that is a reverse of the diffusion pattern.

18. The method of claim 16, wherein the diffusion pattern further comprises at least one second diffusion member, a cross-section of each of the first diffusion members has an arch shape, the cross-section being taken along a line that is substantially perpendicular to a longitudinal direction of the first diffusion members, and a cross-section of the second diffusion member has a triangular shape, the cross-section being taken along a line that is substantially perpendicular to a longitudinal direction of the second diffusion member.

19. The method of claim 18, wherein the second diffusion member is disposed between the first diffusion members.

20. The method of claim 16, wherein each of the first diffusion members has a spherical shape.

21. The method of claim 16, wherein each of the first diffusion members has a triangular pyramid shape.

22. The method of claim 21, wherein the triangular pyramid shape has a rounded top vortex.

23. The method of claim 16, wherein the resin corresponds to photosetting resin that is hardened when ultraviolet light is irradiated thereto.

24. A liquid crystal display (LCD) apparatus comprising:
a backlight assembly including:
a light source that generates light;
a diffusion plate disposed over the light source to diffuse the light; and
a diffusion sheet disposed over the diffusion plate, the diffusion sheet having a base film that is optically transparent and a diffusion layer formed on the base film, the diffusion layer including a diffusion pattern having a plurality of first diffusion members that enhance front-view luminance; and
a display panel that displays an image by using the light.

25. The LCD apparatus of claim 24, wherein the diffusion layer is formed on an upper face of the base film, so that the diffusion layer faces the display panel.

26. The LCD apparatus of claim 24, wherein the diffusion pattern further comprises at least one second diffusion member, a cross-section of each of the first diffusion members has an arch shape, the cross-section being taken along a line that is substantially perpendicular to a longitudinal direction of the first diffusion members, and a cross-section of the second diffusion member has a triangular shape, the cross-section being taken along a line that is substantially perpendicular to a longitudinal direction of the second diffusion member.

27. The LCD apparatus of claim 26, wherein the second diffusion member is disposed between the first diffusion members.

28. The LCD apparatus of claim 24, wherein each of the first diffusion members has a spherical shape.

29. The LCD apparatus of claim 28, wherein the first diffusion members have at least two sizes different from one another.

30. The LCD apparatus of claim 24, wherein each of the first diffusion members has a triangular pyramid shape.

31. The LCD apparatus of claim 30, wherein the triangular pyramid shape has a rounded top vortex.

32. The LCD apparatus of claim 24, wherein the light source corresponds a flat fluorescent lamp.

33. The LCD apparatus of claim 32, wherein the flat fluorescent lamp comprises:
a first substrate;
a second substrate including a plurality of discharge space portions, a plurality of space dividing portions and a sealing portion corresponding to edge portions of the second substrate, the discharge space portions being spaced apart from the first substrate to define a plurality of discharge spaces, each of the space dividing portions being disposed between the discharge space portions, each of the space dividing portions making contact with the first substrate; and
a pair of electrodes that apply a discharge voltage to the discharge spaces.

34. The LCD apparatus of claim 32, wherein the flat fluorescent lamp comprises:
a first substrate;
a second substrate spaced apart from the first substrate to define an inner space;
a plurality of partition members disposed between the first and second substrates to divide the inner space into a plurality of discharge spaces; and
a pair of electrodes that apply a discharge voltage to the discharge spaces.

35. The LCD apparatus of claim 34, wherein the backlight assembly further comprises a reflective polarization film disposed over the diffusion sheet.

36. The LCD apparatus of claim 35, wherein the backlight assembly further comprises:
a receiving container that receives the light source; and
an inverter that generates the discharge voltage.
